(19) United States
(12) Patent Application Publication
(10) Pub. No.: US 2010/0323191 A1
(43) Pub. Date: Dec. 23, 2010

(54) Pressure-Sensitive Adhesive Tape

(75) Inventors: Yuki Sugo, Ibaraki-shi (JP); Yoshio Terada, Ibaraki-shi (JP); Hiroyuki Kondou, Ibaraki-shi (JP); Hitoshi Takano, Ibaraki-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: NITTO DENKO CORPORATION, Ibaraki-shi (JP)

(21) Appl. No.: 12/526,142

(22) PCT Filed: Jan. 24, 2008
(86) PCT No.: PCT/JP2008/050986

§ 371 Date: Aug. 6, 2009

(30) Foreign Application Priority Data
Feb. 7, 2007 (JP) 2007-027481

(51) Int. Cl. B32B 7/12; B32B 5/00

(52) U.S. Cl. 428/332; 428/356

(57) ABSTRACT

A pressure-sensitive adhesive tape, which has a pressure-sensitive adhesive layer with its storage modulus controlled within an adequate range, and which suitably prevents resin leakage during a sealing step in the production of a semiconductor device using a metal lead frame. The pressure-sensitive adhesive tape includes, on a base sheet, a pressure-sensitive adhesive layer containing a silicone-based pressure-sensitive adhesive composition and a lipophilic layered clay mineral dispersed in the silicone-based pressure-sensitive adhesive composition.

### TECHNICAL FIELD

The present invention relates to a pressure-sensitive adhesive tape, and more specifically, to a pressure-sensitive adhesive tape suited for the production of a semiconductor device using a metal lead frame.

### BACKGROUND ART

In LSI-packaging techniques, Chip Size/Scale Package (CSP) techniques have been attracting attention in recent years. Of the CSP techniques, a package containing a lead terminal incorporated therein, typified by a QuadFlat Non-leaded Package (QFN) is one package form attracting particular attention in terms of a size reduction and a high degree of integration.

Of the production methods of QFN, the following production method has been attracting particular attention in recent years: multiple chips for a QFN are systematically arranged on a die pad in the package pattern region of a lead frame, and are collectively sealed with a sealing resin in a die cavity, and then the resultant is cut into individual QFN structures so that productivity per area of the lead frame may be drastically improved.

In the above-mentioned production method of QFN involving collectively sealing multiple semiconductor chips, a region to be clamped with a mold die at the time of sealing with the resin is only the outside of the region sealed with the resin that extends further outward from the package pattern region. Therefore, in the package pattern region, especially the center portion of the region, an outer lead surface cannot be held to the mold die at a sufficient pressure, so it becomes extremely difficult to suppress the leakage of the sealing resin to an outer lead side. As a result, the following problem arises: a terminal or the like of a QFN is coated with the resin.

The following production method of QFN may be particularly effective in solving the above problem: a pressure-sensitive adhesive tape is stuck to the outer lead side of a lead frame, and the leakage of a resin to the outer lead side at the time of sealing with the resin is prevented by a sealing effect utilizing the autohesion strength (masking) of the pressure-sensitive adhesive tape.

In such production method, it is substantially difficult, in terms of handling, to stick the pressure-sensitive adhesive tape after a semiconductor chip has been mounted on the lead frame or wire bonding has been performed. Therefore, the following procedure is desirably adopted: the pressure-sensitive adhesive tape is stuck to the outer pad surface of the lead frame at an initial stage, and the stuck state is maintained until a sealing step with the sealing resin after a step of mounting the semiconductor chip and a wire bonding step.

As described above, the pressure-sensitive adhesive tape is requested to have not only an ability to prevent the leakage of the sealing resin but also such various characteristics as described below: high heat resistance with which the tape can resist the step of mounting the semiconductor chip, and a trouble-free characteristic for delicate operability in the wire bonding step.

A pressure-sensitive adhesive tape composed of a base layer having a specific coefficient of linear thermal expansion and a pressure-sensitive adhesive layer having a specific thickness has been proposed to prevent the leakage of a sealing resin in the production of a semiconductor device (see Patent Document 1). However, the pressure-sensitive adhesive layer of the pressure-sensitive adhesive tape has a low storage modulus, so it is difficult to perform wire bonding normally, and hence it is difficult to prevent the leakage of the sealing resin effectively.

However, when a general pressure-sensitive adhesive tape is utilized while emphasis is placed on high adhesiveness with a view to preventing resin leakage, for example, the following problem arises: the pressure-sensitive adhesive layer of the tape is soft owing to its low elasticity, so it becomes impossible to perform wire bonding actually.

Meanwhile, the following method of producing a semiconductor device has also been known: a wiring resin substrate having an opening portion in which a semiconductor chip is to be placed, a terminal portion to be placed on a surface outside the opening portion, and an outer pad to be placed on the back side surface of the terminal portion is used instead of a lead frame, and a wire bonding step and a sealing step with a sealing resin are performed in a state where the semiconductor chip is placed in the opening portion.

In spite of the fact that the wiring resin substrate having a larger thickness than that of the lead frame is used in the above production method, resin leakage to an outer lead side at the time of sealing with the resin occurs as in the case where the lead frame is used. In addition, the wiring resin substrate is used, so an influence of the pressure-sensitive adhesive layer of a pressure-sensitive adhesive tape in the wire bonding step differs from that in the case where the lead frame is used.

### Patent Document 1: JP 2002-184801 A

### DISCLOSURE OF THE INVENTION

### Problems to be Solved by the Invention

An object of the present invention is to provide a pressure-sensitive adhesive tape which: has a pressure-sensitive adhesive layer with its storage modulus controlled within an adequate range; and can suitably prevent resin leakage during a sealing step in the production of a semiconductor device using a metal lead frame.

### Means for Solving the Problems

The inventors of the present invention have made extensive studies with a view to achieving the above object. As a result, the inventors have found that the above object can be effectively achieved by dispersing a specific layered clay mineral in a silicone-based pressure-sensitive adhesive composition. Thus, the inventors have completed the present invention.

A pressure-sensitive adhesive tape of the present invention includes, on a base sheet, a pressure-sensitive adhesive layer containing a silicone-based pressure-sensitive adhesive composition and a lipophilic layered clay mineral dispersed in the silicone-based pressure-sensitive adhesive composition.

In a preferred embodiment, the layered clay mineral includes a smectite-based clay mineral and/or a mica-based clay mineral.

In a preferred embodiment, 2 to 20 parts by weight of the layered clay mineral are incorporated into 100 parts by weight of the silicone-based pressure-sensitive adhesive composition.

In a preferred embodiment, the pressure-sensitive adhesive layer has a storage modulus of 0.3 to 6.0 MPa.

In a preferred embodiment, the pressure-sensitive adhesive layer has a thickness of 1 to 25 μm.

In a preferred embodiment, the pressure-sensitive adhesive tape of the present invention is used in production of a semiconductor device using a metal lead frame.

### EFFECT OF THE INVENTION

According to the present invention, there can be provided a pressure-sensitive adhesive tape which: has a pressure-sensitive adhesive layer with its storage modulus controlled within an adequate range; and can suitably prevent resin leakage during a sealing step in the production of a semiconductor device using a metal lead frame.

Such effect as described above can be effectively exerted by dispersing a specific layered clay mineral in a silicone-based pressure-sensitive adhesive composition.

### BRIEF DESCRIPTION OF THE DRAWINGS

FIG. 1 is an outline sectional view of a pressure-sensitive adhesive tape according to a preferred embodiment of the present invention.

### DESCRIPTION OF SYMBOLS

10 base sheet
20 pressure-sensitive adhesive layer
30 silicone-based pressure-sensitive adhesive composition
40 lipophilic layered clay mineral
100 pressure-sensitive adhesive tape

### BEST MODE FOR CARRYING OUT THE INVENTION

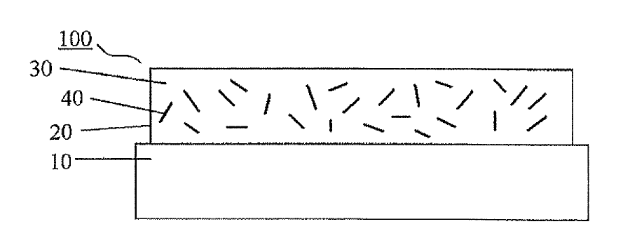

A pressure-sensitive adhesive tape of the present invention has, on a base sheet, a pressure-sensitive adhesive layer containing a silicone-based pressure-sensitive adhesive composition and a lipophilic layered clay mineral dispersed in the pressure-sensitive adhesive composition. Any appropriate thickness can be adopted as the thickness of the pressure-sensitive adhesive layer. The thickness of the pressure-sensitive adhesive layer is preferably 2 to 50 μm, or more preferably 2 to 25 μm. FIG. 1 shows one preferred embodiment of the pressure-sensitive adhesive tape of the present invention. As shown in FIG. 1, a pressure-sensitive adhesive tape 100 of the present invention has a pressure-sensitive adhesive layer 20 on a base sheet 10, and the pressure-sensitive adhesive layer contains a silicone-based pressure-sensitive adhesive composition 30 and a lipophilic layered clay mineral 40. The pieces of the lipophilic layered clay mineral 40 may be arranged substantially parallel to the base sheet 10, or may be arranged substantially perpendicular to the base sheet 10. Alternatively, the following state is permitted: some of the pieces are arranged substantially parallel to the base sheet 10, and the other pieces are arranged substantially perpendicular to the base sheet 10. Alternatively, the pieces may be arranged in a random direction. In consideration of the ease of peeling, the pieces of the lipophilic layered clay mineral 40 are preferably arranged substantially perpendicular to the base sheet 10.

A state where the pieces of the above lipophilic layered clay mineral are arranged can be found by observing a section of the pressure-sensitive adhesive tape with an electron microscope (SEM or TEM).

The phrase “arranged substantially perpendicular to the base sheet” means that the pieces of the lipophilic layered clay mineral are arranged at an angle of preferably 60° to 120°, more preferably 70° to 110°, or still more preferably 80° to 100° relative to the principal surface of the base sheet. The phrase “arranged substantially parallel to the base sheet” means that the pieces of the lipophilic layered clay mineral are arranged at an angle of preferably −30° to 30°, more preferably −20′ to 20′, or still more preferably −10° to 10° relative to the principal surface of the base sheet.

Any appropriate composition such as a commercially available silicone-based pressure-sensitive adhesive can be adopted as the above silicone-based pressure-sensitive adhesive composition. When the silicone-based pressure-sensitive adhesive composition is used, the heat resistance of the pressure-sensitive adhesive tape is high, and the storage modulus and pressure-sensitive adhesive strength of the pressure-sensitive adhesive tape at high temperatures easily become appropriate values. A peroxide crosslinkable pressure-sensitive adhesive, an addition reaction-type pressure-sensitive adhesive, a dehydrogenation reaction-type pressure-sensitive adhesive, or a moisture curable pressure-sensitive adhesive is preferably used as the above silicone-based pressure-sensitive adhesive composition. Of those, the addition reaction-type pressure-sensitive adhesive is particularly suitable because it contains small amounts of impurities.

The above silicone-based pressure-sensitive adhesive composition may contain any appropriate additive to such an extent that the effect of the present invention is not impaired.

The lipophilic layered clay mineral is obtained by subjecting a layered silicate mineral having an exchangeable cation in its crystal structure to a lipophilic treatment.

Any appropriate layered silicate mineral can be adopted as the layered silicate mineral. Examples of the above layered silicate mineral include: smectite-based clay minerals such as montmorillonite, saponite, hectorite, and stevensite; and mica-based clay minerals such as fluoro-tetrasilicic mica. They may be used alone or in combination; a mica-based clay mineral is preferably used because the pressure-sensitive adhesive tape can obtain good toughness.

The lipophilic layered clay mineral is preferably of a plate-like shape. In this case, the lipophilic layered clay mineral has a thickness of preferably about 0.1 to 10 nm, or more preferably 0.5 to 5 nm. In addition, the lipophilic layered clay mineral has a width of preferably 10 to 10,000 nm, more preferably 20 to 7,000 nm, or still more preferably 50 to 5,000 nm. The terms “thickness” and “width” as used herein each refer to an average length. The average length can be determined by actual measurement with an electron microscope (TEM) photograph. When the above width exceeds 10,000 nm, the elongation of the pressure-sensitive adhesive tape may reduce. When the width is less than 10 nm, a breaking stress for the pressure-sensitive adhesive tape may increase.

The above lipophilic layered clay mineral is preferably as follows: an exchangeable cation between layers is subjected to an ion exchange treatment with an organic cation or the like so that a gap between the layers may be made lipophilic.

The exchangeable cation is a metal ion present on the surface of the crystal layer of a layered silicate mineral such as a sodium ion or a calcium ion. A lipophilic monomer cannot penetrate into a gap between layers of the layered silicate mineral because such ion is hydrophilic. Accordingly, a good dispersed product cannot be obtained. In order that the monomer may be caused to penetrate into the gap between the layers, the exchangeable cation must be subjected to ion exchange with a lipophilic, cationic surfactant or the like.

Examples of the cationic surfactant include quaternary ammonium salts and quaternary phosphonium salts.

Examples of the quaternary ammonium salt include lauryl trimethyl ammonium salts, stearyl trimethyl ammonium salts, trioctyl ammonium salts, distearyl dimethyl ammonium salts, distearyl dibenzyl ammonium salts, and ammonium salts each having a substituted propylene oxide skeleton. They may be used alone or in combination.

Examples of the quaternary phosphonium salts include decyl triphenyl phosphonium salts, methyl triphenyl phosphonium salts, lauryl trimethyl phosphonium salts, stearyl trimethyl phosphonium salts, distearyl dimethyl phosphonium salts, and distearyl dibenzyl phosphonium salts. They may be used alone or in combination.

In the pressure-sensitive adhesive tape of the present invention, the layers of the above lipophilic layered clay mineral are preferably peeled from each other to a sufficient extent before the use of the pressure-sensitive adhesive tape. Any appropriate method can be adopted as a method of peeling the layers. For example, ultrasonic peeling, high-pressure shear peeling, ultra-high speed stirring, or supercritical CO₂ stirring is employed; a high-pressure shear peeling method is particularly preferable because the method allows one to peel the layers from each other without crushing the lipophilic layered clay mineral. The layers of the lipophilic layered clay mineral are preferably peeled to such an extent that six or less silicate layers of the layered clay mineral overlap each other on average. When the average exceeds six, the total surface area of the layered clay mineral reduces, and an interaction between the layered clay mineral and an organic component reduces, so the toughness of the pressure-sensitive adhesive may reduce. The average number of overlapping layers can be analyzed with an electron microscope (TEM).

The content of the above lipophilic layered clay mineral is preferably 2 to 20 parts by weight, more preferably 3 to 20 parts by weight, or still more preferably 4 to 10 parts by weight with respect to 100 parts by weight of the above silicone-based pressure-sensitive adhesive composition. When the content is less than 2 parts by weight, an effect of the present invention may not be sufficiently exerted. When the content is larger than 20 parts by weight, the viscosity of the pressure-sensitive adhesive layer increases, so an external appearance when the pressure-sensitive adhesive tape is applied may reduce.

The above pressure-sensitive adhesive layer may contain any appropriate component in addition to the above silicone-based pressure-sensitive adhesive composition and the above lipophilic layered clay mineral to such an extent that the object of the present invention is not impaired.

The above pressure-sensitive adhesive layer has a storage modulus of preferably 0.3 to 6.0 MPa, more preferably 0.5 to 5.0 MPa, or still more preferably 1.0 to 5.0 MPa. When the storage modulus of the pressure-sensitive adhesive layer is 0.3 MPa or less, the pressure-sensitive adhesive layer is so soft that, for example, the following problem may occur: a metal lead frame moves at the time of wire bonding in the production of a semiconductor device using the lead frame, so it becomes impossible to perform wire bonding. In addition, when the storage modulus of the pressure-sensitive adhesive layer is 6.0 MPa or more, the pressure-sensitive adhesive layer becomes so hard that the following problem may occur: the pressure-sensitive adhesive strength of the pressure-sensitive adhesive layer reduces, so the pressure-sensitive adhesive layer peels off the lead frame. In the present invention, the storage modulus of the pressure-sensitive adhesive layer is a value measured with a viscoelastic spectrometer in conformance with ASTM STP 846.

As the base sheet, any appropriate base sheet may be employed. Examples thereof include a polyethylene terephthalate (PET) film, a polyethylene naphthalate (PEN) film, a polyether sulfone (PES) film, a polyether imide (PEI) film, a polysulfone (PSF) film, a polyphenylene sulfide (PPS) film, a polyether ether ketone (PEEK) film, a polyarylate (PAR) film, an aramide film, a polyimide film, and a liquid crystal polymer (LOP) film. In view of heat resistance, a film formed of a polyimide material is preferred.

Any appropriate thickness can be adopted as the thickness of the base sheet. The thickness of the base sheet is preferably 5 to 250 μm in order that the breaking and fracturing of the base sheet may be prevented, and the ease of handling of the base sheet may be kept at a good level.

Any appropriate method can be adopted as a method of producing the pressure-sensitive adhesive tape of the present invention. For example, the following method is employed. First, an upper portion of any substrate is coated with the silicone-based pressure-sensitive adhesive composition containing the above lipophilic layered clay mineral, and the silicone-based pressure-sensitive adhesive composition is dried so that a pressure-sensitive adhesive sheet containing the above lipophilic layered clay mineral dispersed in the silicone-based pressure-sensitive adhesive composition may be produced. Then, the pressure-sensitive adhesive sheet is formed on the base sheet. Alternatively, the following method is employed: an upper portion of the base sheet is coated with the silicone-based pressure-sensitive adhesive composition containing the above lipophilic layered clay mineral, and then the silicone-based pressure-sensitive adhesive composition is dried so as to be fixed.

In the pressure-sensitive adhesive tape of the present invention, a protective film may be used in order to protect the pressure-sensitive adhesive layer. Examples of the protective film include plastic films formed of polyvinyl chloride, a vinyl chloride copolymer, polyethylene terephthalate, polybutylene terephthalate, polyurethane, a ethylene-vinyl acetate copolymer, an ionomer resin, an ethylene-(meth)acrylic acid copolymer, an ethylene-(meth)acrylate copolymer, polystyrene, polycarbonate, or the like, each of which is subjected to releasing treatment with a silicone-based, long-chain alkyl-based, fluorine-based, aliphatic amide-based, or silica-based releasing agent. In addition, as the film of the polyolefin resin base such as polyethylene, polypropylene, polybutene, polybutadiene, and polymethyl pentene has a releasing property even without using a releasing treatment agent, and hence, the film alone can be used as a protective film. The thickness of the protective film is preferably about 10 to 100 μm.

The pressure-sensitive adhesive tape of the present invention is applicable to any appropriate application. The pressure-sensitive adhesive tape is particularly suitably used in the production of a semiconductor device using a metal lead frame because the pressure-sensitive adhesive tape can suitably prevent resin leakage during a sealing step in the production of the semiconductor device using a metal lead frame.

### EXAMPLES

Hereinafter, the present invention is described more specifically by way of examples. However, the present invention is not limited by these examples. In addition, the terms “part (s)” in the examples refer to “part(s) by weight”.

### Example 1

A polyimide film having a thickness of 25 μm (manufactured by DU PONT-TORAY CO., LTD., trade name: Kapton 100H) was used as a base sheet. A pressure-sensitive adhesive layer obtained by dispersing 20 parts by weight of a lipophilic layered clay mineral (manufactured by CO-OP Chemical, trade name: SOMASIF MAE) in 100 parts by weight of a silicone-based pressure-sensitive adhesive (manufactured by Dow Corning Toray Co., Ltd., trade name: SD-4585) was provided on the base sheet, whereby a pressure-sensitive adhesive tape (1) was produced. The pressure-sensitive adhesive layer of the pressure-sensitive adhesive tape (1) had a thickness of 10 μm.

### Example 2

A polyimide film having a thickness of 25 μm (manufactured by DU PONT-TORAY CO., LTD., trade name: Kapton 100H) was used as a base sheet. A pressure-sensitive adhesive layer obtained by dispersing 10 parts by weight of a lipophilic layered clay mineral (manufactured by CO-OP Chemical, trade name: SOMASIF MAE) in 100 parts by weight of a silicone-based pressure-sensitive adhesive (manufactured by Dow Corning Toray Co., Ltd., trade name: SD-4585) was provided on the base sheet, whereby a pressure-sensitive adhesive tape (2) was produced. The pressure-sensitive adhesive layer of the pressure-sensitive adhesive tape (2) had a thickness of 10 μm.

### Example 3

A polyimide film having a thickness of 25 μm (manufactured by DU PONT-TORAY CO., LTD., trade name: Kapton 100H) was used as a base sheet. A pressure-sensitive adhesive layer obtained by dispersing 5 parts by weight of a lipophilic layered clay mineral (manufactured by CO-OP Chemical, trade name: SOMASIF MAE) in 100 parts by weight of a silicone-based pressure-sensitive adhesive (manufactured by Dow Corning Toray Co., Ltd., trade name: SD-4585) was provided on the base sheet, whereby a pressure-sensitive adhesive tape (3) was produced. The pressure-sensitive adhesive layer of the pressure-sensitive adhesive tape (3) had a thickness of 10 μm.

### Example 4

A polyimide film having a thickness of 25 μm (manufactured by DU PONT-TORAY CO., LTD., trade name: Kapton 100H) was used as a base sheet. A pressure-sensitive adhesive layer obtained by dispersing 20 parts by weight of a lipophilic layered clay mineral (manufactured by CO-OP Chemical, trade name: SOMASIF MAE) in 100 parts by weight of a silicone-based pressure-sensitive adhesive (manufactured by Dow Corning Toray Co., Ltd., trade name: SD-4585) was provided on the base sheet, whereby a pressure-sensitive adhesive tape (4) was produced. The pressure-sensitive adhesive layer of the pressure-sensitive adhesive tape (4) had a thickness of 20 μm.

### Example 5

A polyimide film having a thickness of 25 μm (manufactured by DU PONT-TORAY CO., LTD., trade name: Kapton 100H) was used as a base sheet. A pressure-sensitive adhesive layer obtained by dispersing 10 parts by weight of a lipophilic layered clay mineral (manufactured by CO-OP Chemical, trade name: SOMASIF MAE) in 100 parts by weight of a silicone-based pressure-sensitive adhesive (manufactured by Dow Corning Toray Co., Ltd., trade name: SD-4585) was provided on the base sheet, whereby a pressure-sensitive adhesive tape (5) was produced. The pressure-sensitive adhesive layer of the pressure-sensitive adhesive tape (5) had a thickness of 20 μm.

### Example 6

A polyimide film having a thickness of 25 μm (manufactured by DU PONT-TORAY CO., LTD., trade name: Kapton 100H) was used as a base sheet. A pressure-sensitive adhesive layer obtained by dispersing 5 parts by weight of a lipophilic layered clay mineral (manufactured by CO-OP Chemical, trade name: SOMASIF MAE) in 100 parts by weight of a silicone-based pressure-sensitive adhesive (manufactured by Dow Corning Toray Co., Ltd., trade name: SD-4585) was provided on the base sheet, whereby a pressure-sensitive adhesive tape (6) was produced. The pressure-sensitive adhesive layer of the pressure-sensitive adhesive tape (6) had a thickness of 20 μm.

### Example 7

A polyimide film having a thickness of 25 μm (manufactured by DU PONT-TORAY CO., LTD., trade name: Kapton 100H) was used as a base sheet. A pressure-sensitive adhesive layer obtained by dispersing 1 part by weight of a lipophilic layered clay mineral (manufactured by CO-OP Chemical, trade name: SOMASIF MAE) in 100 parts by weight of a silicone-based pressure-sensitive adhesive (manufactured by Dow Corning Toray Co., Ltd., trade name: SD-4585) was provided on the base sheet, whereby a pressure-sensitive adhesive tape (7) was produced. The pressure-sensitive adhesive layer of the pressure-sensitive adhesive tape (7) had a thickness of 10 μm.

### Example 8

A polyimide film having a thickness of 25 μm (manufactured by DU PONT-TORAY CO., LTD., trade name: Kapton 100H) was used as a base sheet. A pressure-sensitive adhesive layer obtained by dispersing 20 parts by weight of a lipophilic layered clay mineral (manufactured by CO-OP Chemical, trade name: SOMASIF MAE) in 100 parts by weight of a silicone-based pressure-sensitive adhesive (manufactured by Dow Corning Toray Co., Ltd., trade name: SD-4585) was provided on the base sheet, whereby a pressure-sensitive adhesive tape (8) was produced. The pressure-sensitive adhesive layer of the pressure-sensitive adhesive tape (8) had a thickness of 50 μm.

### Comparative Example 1

A polyimide film having a thickness of 25 μm (manufactured by DU PONT-TORAY CO., LTD., trade name: Kapton 100H) was used as a base sheet. A pressure-sensitive adhesive layer constituted of a silicone-based pressure-sensitive adhesive (manufactured by Dow Corning Toray Co., Ltd., trade name: SD-4585) was provided on the base sheet, whereby a pressure-sensitive adhesive tape (C1) was produced. The pressure-sensitive adhesive layer of the pressure-sensitive adhesive tape (C1) had a thickness of 10 μm.

### Comparative Example 2

A polyimide film having a thickness of 25 μm (manufactured by DU PONT-TORAY CO., LTD., trade name: Kapton 100H) was used as a base sheet. A pressure-sensitive adhesive layer constituted of a silicone-based pressure-sensitive adhesive (manufactured by Dow Corning Toray Co., Ltd., trade name: SD-4585) was provided on the base sheet, whereby a pressure-sensitive adhesive tape (C2) was produced. The pressure-sensitive adhesive layer of the pressure-sensitive adhesive tape (C2) had a thickness of 20 μm.

### Evaluation

Each of the pressure-sensitive adhesive tapes produced in Examples 1 to 8, and Comparative Examples 1 and 2 was stuck to the outer pad side of a copper lead frame on which 4×4 QFN's of a 16-pin-per-side type each having a terminal portion subjected to silver plating were arranged.

A semiconductor chip was bonded to the die pad portion of the lead frame with an epoxy phenol-based silver paste, and was then fixed by being cured at 180° C. for about 1 hour.

Next, the lead frame was fixed to a heat block heated to 180° C. in a state where the lead frame was sucked in a vacuum from the side of the pressure-sensitive adhesive tape. Further, the peripheral portion of the lead frame was fixed by being held with a window clamper.

The resultant was subjected to wire bonding with a 115-KHz wire bonder (manufactured by SHINKAWA LTD., trade name: UTC-300BIsuper) and a gold wire having a diameter of 25 μm (manufactured by Tanaka Kikinzoku Kogyo K.K., trade name: GMG-25) under the following conditions.

| | | |
|---|---|---|
| First bonding pressure: | 130 | g |
| First bonding ultrasonic intensity: | 550 | mW |
| First bonding application time: | 8 | msec |
| Second bonding pressure: | 130 | g |
| Second bonding ultrasonic intensity: | 500 | mW |
| Second bonding application time: | 7 | msec |

Further, the resultant was molded together with an epoxy-based sealing resin (manufactured by Nitto Denko Corporation, trade name: HC-300B) by using a molding machine (manufactured by TOWA, trade name: Model-Y-series) at 175° C. for a preheating time of 20 seconds, an injection time of 12 seconds, and a curing time of 120 seconds. After that, the pressure-sensitive adhesive tape was peeled.

Further, the resultant was subjected to post-mold curing at 175° C. for about 3 hours so that the resin might be sufficiently cured. After that, the resultant was cut with a dicer, whereby individual QFN-type semiconductor devices were obtained.

A QFN obtained by using each of the pressure-sensitive adhesive tapes produced in Examples 1 to 8, and Comparative Examples 1 and 2 as described above was evaluated for resin leakage. A method for the evaluation was as described below. A lead pad having a resin adhering thereon was regarded as a failed lead pad, and a failure ratio was determined from the number of failed lead pads in 100 lead pads.

Table 1 shows the results of the evaluation.

TABLE 1

| | | Storage | Thickness of | |
|---|---|---|---|---|
| | | modulus of | pressure- | |
| | Layered clay | pressure- | sensitive | |
| | mineral | sensitive | adhesive | Failure |
| | (part(s) by | adhesive layer | layer | ratio |
| | weight) | (MPa) | (μm) | (%) |
| Example 1 | 20 | 5.0 | 10 | 0 |
| Example 2 | 10 | 1.0 | 10 | 0 |
| Example 3 | 5 | 0.5 | 10 | 2 |
| Example 4 | 20 | 5.0 | 20 | 3 |
| Example 5 | 10 | 1.0 | 20 | 5 |
| Example 6 | 5 | 0.5 | 20 | 8 |
| Example 7 | 1 | 0.15 | 10 | 10 |
| Example 8 | 20 | 5.0 | 50 | 10 |
| Comparative | 0 | 0.1 | 10 | 40 |
| Example 1 | | | | |
| Comparative | 0 | 0.1 | 20 | 50 |
| Example 2 | | | | |

Table 1 shows that the pressure-sensitive adhesive tape of the present invention can suitably prevent resin leakage during a sealing step in the production of a semiconductor device using a metal lead frame.

### INDUSTRIAL APPLICABILITY

The pressure-sensitive adhesive tape of the present invention is particularly suitably used in the production of a semiconductor device using a metal lead frame because the pressure-sensitive adhesive tape can suitably prevent resin leakage during a sealing step in the production of the semiconductor device using a metal lead frame.

1. A pressure-sensitive adhesive tape comprising, on a base sheet, a pressure-sensitive adhesive layer containing a silicone-based pressure-sensitive adhesive composition and a lipophilic layered clay mineral dispersed in the silicone-based pressure-sensitive adhesive composition.

2. A pressure-sensitive adhesive tape according to claim 1, wherein the layered clay mineral comprises at least one of a smectite-based clay mineral or a mica-based clay mineral.

3. A pressure-sensitive adhesive tape according to claim 1, wherein 2 to 20 parts by weight of the layered clay mineral are incorporated into 100 parts by weight of the silicone-based pressure-sensitive adhesive composition.

4. A pressure-sensitive adhesive tape according to claim 1, wherein the pressure-sensitive adhesive layer has a storage modulus of 0.3 to 6.0 MPa.

5. A pressure-sensitive adhesive tape according to claim 1, wherein the pressure-sensitive adhesive layer has a thickness of 2 to 50 μm.

6. A pressure-sensitive adhesive tape according to claim 1, wherein the pressure-sensitive adhesive tape is used in production of a semiconductor device using a metal lead frame.

7. A pressure-sensitive adhesive tape according to claim 2, wherein 2 to 20 parts by weight of the layered clay mineral are incorporated into 100 parts by weight of the silicone-based pressure-sensitive adhesive composition.

8. A pressure-sensitive adhesive tape according to claim 2, wherein the pressure-sensitive adhesive layer has a storage modulus of 0.3 to 6.0 MPa.

9. A pressure-sensitive adhesive tape according to claim 3, wherein the pressure-sensitive adhesive layer has a storage modulus of 0.3 to 6.0 MPa.

10. A pressure-sensitive adhesive tape according to claim 2, wherein the pressure-sensitive adhesive layer has a thickness of 2 to 50 μm.

11. A pressure-sensitive adhesive tape according to claim 3, wherein the pressure-sensitive adhesive layer has a thickness of 2 to 50 μm.

12. A pressure-sensitive adhesive tape according to claim 4, wherein the pressure-sensitive adhesive layer has a thickness of 2 to 50 μm.

13. A pressure-sensitive adhesive tape according to claim 2, wherein the pressure-sensitive adhesive tape is used in production of a semiconductor device using a metal lead frame.

14. A pressure-sensitive adhesive tape according to claim 3, wherein the pressure-sensitive adhesive tape is used in production of a semiconductor device using a metal lead frame.

15. A pressure-sensitive adhesive tape according to claim 4, wherein the pressure-sensitive adhesive tape is used in production of a semiconductor device using a metal lead frame.

16. A pressure-sensitive adhesive tape according to claim 5, wherein the pressure-sensitive adhesive tape is used in production of a semiconductor device using a metal lead frame.
